(19) United States
(12) Patent Application Publication
(10) Pub. No.: US 2024/0219238 A1
(43) Pub. Date: Jul. 4, 2024

(54) Device for the Spectrally Resolved Detection of Optical Radiation

(71) Applicant: 4D Photonics GmbH, Isernhagen (DE)

(72) Inventors: Christoph Franz, Negenborn (DE); Oliver Bruchwald, Wunstorf (DE); Max Funck, Potsdam (DE)

(21) Appl. No.: 18/288,579

(22) PCT Filed: May 2, 2022
(86) PCT No.: PCT/DE2022/100328

§ 371 Date: Oct. 27, 2023

(30) Foreign Application Priority Data
May 6, 2021 (DE) 102021111892.1

(51) Int. Cl. G01J 5/0801; G01J 5/00; G01J 5/08; G01J 5/0806; G01J 5/20; G01J 5/22; G01J 5/60

(52) U.S. Cl. CPC G01J 5/0801; G01J 5/0806; G01J 5/0814; G01J 5/22; G01J 5/601; G01J 5/0018; G01J 2005/202; G01J 2005/607

(57) ABSTRACT

The invention relates to a device for the spectrally resolved detection of optical radiation (5) during a thermal process, more particularly during laser processing. The device comprises at least two elements (4.1, 4.2) which are light-sensitive in one 5 predefined wavelength range each, a reflective diffraction grating (2), and at least one lens (3) for focusing and collimation. The device optionally comprises a reflective beam splitter (1) designed to divide the incident optical radiation (5) into a plurality of partial beams (5.1, 5.2). Said reflective beam splitter (1) is disposed upstream of the at least one lens (3) along the propagation direction of the optical radiation (5). The partial beams (5.1, 5.2) are spectrally split by means of the diffraction grating (2), and at least the first order of diffraction is deflected back through the at least one lens (3) onto one of the light-sensitive elements (4.1, 4.2).

### CROSS REFERENCE TO RELATED APPLICATIONS

This application is the U.S. national stage of International Application No. PCT/DE2022/100328, filed on 2022 May 2. The international application claims the priority of DE 102021111892.1 filed on 2021 May 6; all applications are incorporated by reference herein in their entirety.

### BACKGROUND

The invention relates to a device for spectrally resolved detection of optical radiation during a thermal process. The invention can be used in particular for laser material processing, such as laser cutting and laser welding, for example.

In the case of laser material processing, there is a correlation between the laser material interaction, the process radiation emitted and the processing result. It is known from the prior art to detect the process radiation or process light produced during laser material processing in its entirety or parts thereof using photodiodes in order to be able to determine process changes by measurement. The evaluation and analysis of the signal curves, as well as the comparison with previously recorded reference signals, enables the implementation of reliable and fast inline process monitoring.

For physical reasons, photodiodes are only sensitive in a limited spectral range. Due to this limitation, different photodiodes (also in combination) are used to detect the process radiation, namely silicon photodiodes (Si) in the visible spectrum (VIS) and indium gallium arsenide photodiodes (InGaAs) or germanium photodiodes (Ge) in the near-infrared spectrum (NIR).

In the photodiode, the incident photons generate an electrical current that is proportional to their number. Since the electrical photocurrent generated by the photodiode is usually very low (due to the typically very low light intensities), it must be amplified in a suitable, low-noise manner.

In the non-filtered state, the entire process emissions in the spectral range covered by the photodiode are detected. The measurement signal therefore corresponds to the integral of the light intensity in the detected spectrum.

Since the intensity in the region of the laser or processing wavelength is generally multiple times higher than the intensity of the secondary process radiation in the remaining spectrum, corresponding optical filtering is necessary, in order to block the laser wavelength with high optical density. Otherwise the laser radiation would be weighted too heavily or would outshine the process radiation and make its evaluation impossible. Interference from external lighting (e.g. pilot lasers) must also be filtered out of the spectral range captured by the photodiode using additional filters.

An alternative possibility is the optical separation of wavelength ranges by partially transmissive mirrors or prisms, as a result of which the evaluation of a selected or a plurality of further wavelength ranges is possible. It is thus possible to carry out a simultaneous evaluation of high-intensity primary radiation and weak secondary radiation.

It is also known to use spectrometers in order to analyze the radiation available on the input side in a spectrally resolved manner. For this purpose, there are spectrometers of different designs and different sensitivities. For example, compact spectrometers with curved dispersive elements (gratings) are known, which simultaneously also have a focusing/collimating effect. In this case, the grating is illuminated by the divergent light of the gap (or a fiber) and itself has a focusing effect, since it is mounted in a curved manner on the so-called Rowland circle. However, curved gratings can hardly be used economically for small piece numbers.

More cost-effective planar gratings, on the other hand, require additional optical components for collimation and focusing. For this purpose, two concave mirrors are generally used; however, the use of lenses is also possible, but is avoided, since these result in undesired imaging errors.

DE 10 2016 225 344 A1 describes a polychromator with a substrate and a functional element that has an optical spectral decomposing effect. The optically spectrally decomposing functional element is designed to spectrally decompose electromagnetic radiation originating from an inlet opening, for example, light reflected from an optional radiation source on a sample such that a spectrally decomposed spectrum is obtained.

EP 3 306 263 A1 discloses a chromatic confocal distance sensor having a housing in which a polychromatic light source, an imaging optical unit with a chromatic longitudinal aberration, a spectrometer and a planar beam splitter surface are arranged.

DE 27 58 141 A1 also describes a spectrophotometer with a reflective dispersion element and a multi-photodetector arranged in the evaluation plane.

A disadvantage of the known spectrometers is the low light yield at high spectral resolution. In order to achieve the highest possible spectral resolution, the use of one or more apertures is typically necessary due to the diffraction limitation of optical systems. The amount of radiation emitted by the measurement object is limited by these apertures so that the thinnest possible beam bundle hits the sensitive surface of the sensors. This ensures that even smaller wavelength differences can be resolved after passing through a prism or diffraction grating through the now distinguishable point of incidence. The amount of radiation shaded by the aperture is then no longer available for evaluation.

A disadvantage is that the processing optics typically used in laser technology transmit only little process radiation because they are optimized to the laser wavelengths. Since commercially available spectrometers (e.g. with line scan cameras or photodiode arrays) generally work with temporal integration, very long integration times are required for particularly weak radiation, which means that only very low measurement rates can be realized.

What is desirable for process monitoring is a spectrometer that is particularly sensitive to radiation in order to achieve high temporal resolution (by reducing the integration time) and also offers a high dynamic range. The high dynamics are required because both very light-weak and very bright processes have to be captured both within a seam and from seam to seam on a component.

### SUMMARY

The invention relates to a device for the spectrally resolved detection of optical radiation (5) during a thermal process, more particularly during laser processing. The device comprises at least two elements (4.1, 4.2) which are light-sensitive in one predefined wavelength range each, a reflective diffraction grating (2), and at least one lens (3) for focusing and collimation. The device optionally comprises a reflective beam splitter (1) designed to divide the incident optical radiation (5) into a plurality of partial beams (5.1, 5.2). Said reflective beam splitter (1) is disposed upstream of the at least one lens (3) along the propagation direction of the optical radiation (5). The partial beams (5.1, 5.2) are spectrally split by means of the diffraction grating (2), and at least the first order of diffraction is deflected back through the at least one lens (3) onto one of the light-sensitive elements (4.1, 4.2).

### DETAILED DESCRIPTION

The object of the invention is to provide a device for the spectrally resolved detection of optical radiation during a thermal process, in particular laser processing, which, due to its compact structure, can be integrated, inter alia, into a laser machining head, wherein a spectral resolution should be possible with a high light yield at the same time, so that a high measurement rate is available. In addition, rapid switching between individual measurement ranges and a large dynamic range is to be possible.

The object is achieved by a device for spectrally resolved detection of optical radiation having the characterizing features according to patent claim 1. Appropriate embodiments of the invention can be found in the dependent claims.

According to the disclosure, the device for spectrally resolved detection of optical radiation during a thermal process, in particular laser processing, comprises at least one light-sensitive element for spectral resolution in a predefined wavelength range, a reflective diffraction grating and at least one lens for focusing and/or collimation. The device preferably has a converging lens for focusing and/or collimation and at least two light-sensitive elements for spectral resolution, each in a predefined wavelength range.

Preferably, one light-sensitive element comprises a plurality of photoactive individual elements, i.e. one light-sensitive element is formed from a group of photoactive individual elements. For example, the light-sensitive elements for spectral resolution can be constructed from at least two individual elements, for example in the form of grouped photodiodes, or can also be designed as integrated components, for example photodiode arrays.

The at least one lens for focusing and/or collimation is arranged in front of the diffraction grating, wherein the optical radiation deflected by the at least one lens onto the diffraction grating is spectrally decomposed and focused back through the at least one lens onto the or one of the light-sensitive elements. This diffraction grating can have different diffraction properties in certain regions. For example, a first region is designed specifically for the spectral decomposition of radiation with wavelengths in the visible region and a second region of the diffraction grating for the spectral decomposition of radiation with wavelengths in the near infrared.

In the device according to the invention, the complexity of a curved grating is dispensed with and the collimating and focusing effect is achieved by the double beam passage through the at least one lens as an optical element. This can be a lens, which in the simplest case is only one lens. Thus, the perfect collimation on the grid is deviated. The coloring and imaging errors that occur generally prevent the use of a corresponding arrangement in high-resolution spectrometers, but can be accepted with low spectral resolution, as in the device according to the invention.

According to the invention, the device for spectrally resolved detection of optical radiation has a deflection mirror, referred to below as a mirror, which is arranged in front of the at least one lens and the diffraction grating along the propagation direction of the optical radiation, i.e. the radiation is directed from the mirror through the at least one lens onto the diffraction grating.

Due to this arrangement of the individual optical elements relative to one another, in particular the dual use of the at least one lens in the beam path (namely for collimation and/or pre-focusing of the beams onto the diffraction grating and for focusing the beams spectrally decomposed by the diffraction grating onto the light-sensitive elements), as well as the integration of reflective properties into the diffraction grating, the device can be implemented in a comparatively compact installation space. In particular, this arrangement of the beam path using a further mirror allows the light-sensitive element to be arranged with its light-sensitive surface aligned parallel to the process light beam entering the device, thereby minimizing the installation space. This makes it possible to integrate the device, for example, into a conventional laser processing head without significant, space-consuming attachments.

The advantage of the device according to the invention is therefore the possibility of using multispectral sensors in a comparatively small installation space.

Due to the spectral evaluation, for example in welding processes, improved error detection and classification of errors compared to the prior art are made possible. By eliminating the need for small apertures, the device can also be used in processes with little available light.

The device is furthermore designed in such a way that the mirror is designed as reflecting the beam splitter, which splits the incident optical radiation into a plurality of partial beams. Herein the number of partial beams typically corresponds to the number of light-sensitive elements. Preferably, two partial beams are generated which are each directed onto a light-sensitive element.

In particular, the beam splitter can be designed in such a way that it generates partial beams in determined wavelength ranges (for example VIS and NIR) different from the other partial beams. For this purpose, the beam splitter can be constructed from an arrangement of differently oriented partially reflecting mirrors.

By a spatially tilted arrangement of the partially reflecting mirrors, the partial beams generated in this way—even from different spectral ranges—can be directed to adjacent areas of the diffraction grating or gratings, but at the same time use the same lens for focusing and/or collimation.

As a result, an optical separation into two or more spectral ranges is possible in such a way that they are detected with different light-sensitive elements.

This results in the following mode of operation of the device:

To separate primary laser radiation and secondary process radiation, a partially transparent mirror can be used, which is located in front of the actual measurement setup.

The process radiation to be analyzed is directed onto the reflective beam splitter, for example by means of an achromat and a negative lens. The reflective beam splitter divides the incoming process light beam into the desired number of partial beams, preferably into two partial beams, and deflects these partial beams through the at least one lens onto adjacent regions of the diffraction grating(s).

The partial beams are spectrally split up by means of the diffraction grating and focus on in each case one light-sensitive element through the at least one lens. Since the spectrally split partial beams propagate in a fan-shaped manner from the diffraction grating to the light-sensitive element, the light-sensitive elements preferably have a substantially linear geometry.

Furthermore, it can be provided that the device comprises an evaluation device connected to the light-sensitive elements, which, if necessary, electronically amplified and evaluates the amounts of radiation detected by the light-sensitive elements in a spectrally separated manner.

The fact that the quantities of light detected by the light-sensitive elements can be read out electronically and, if necessary, amplified gradually accordingly results in a high dynamic range of the device. In particular, by switching amplification stages on or off, rapid switching is possible in the case of weak and intense light emissions.

Furthermore, it can be provided that the light-sensitive elements comprise a plurality of photoactive individual elements, which are preferably arranged next to one another along, for example, a line, wherein each of these photoactive individual elements being connected to a separate channel input of the evaluation device. All photoactive individual elements of a light-sensitive element are preferably sensitive in the same wavelength range. In particular, the evaluation device can be configured to combine a predetermined number of adjacent channels into channel groups, so that the radiation detected by the photoactive individual elements connected to these channels can in each case be combined to form a single light signal.

Thus, by reducing the resolution, the photoactive surface can be enlarged, so that an improved signal-to-noise ratio can be achieved even in low light due to the now relatively large photoactive area. In addition, the now lower resolution eliminates the need for particularly good focusing and the use of small apertures, meaning that overall more radiation is captured for evaluation.

By assigning each of the photoactive individual elements to a dedicated input channel of the evaluation device, the evaluation device can alternatively or additionally be set up to only use the signal from selected channels for evaluation, while the remaining channels remain switched off. In this way, since only light of a predefined wavelength range is incident on each of the photoactive individual elements due to the spectral splitting of the partial beams by the diffraction grating and their fan-like spread, the process light to be analyzed can be analyzed in a selected frequency band, that is to say a very narrow wavelength range. This results in the possibility of saving spectrally rigidly limiting optical filters in the measurement setup.

According to one embodiment, each of the light-sensitive elements is sensitive in a predefined wavelength range which is different from that of the other light-sensitive elements. Thus, a first light-sensitive element can be sensitive in the visible wavelength range and a second light-sensitive element can be sensitive in the near infrared range. Accordingly, according to this example, the device is constructed in such a way that the partial beam generated by the beam splitter in the visible wavelength range is directed to the first and the partial beam in the near infrared range is directed to the second light-sensitive element.

By specifically reading and calculating a plurality of or selected spectral ranges, the device can be used as a quotient pyrometer in such a way that the ideal measuring ranges for the temperature to be measured are always used.

A realization of multiple quotient pyrometer at the same time is also possible. This means that measurements can also be carried out that provide support points for Planck's radiation law in order to enable greater measurement accuracy.

One embodiment of the device provides that the light-sensitive elements are 16-channel photodiode arrays. Here, a first light-sensitive element can contain silicon photodiodes (Si) for light detection in the visible spectrum (VIS) and a second light-sensitive element can contain indium gallium arsenide photodiodes (InGaAs) for light detection in the near-infrared spectrum (NIR).

When using diffraction gratings, in addition to the 1st diffraction order, which contains the information of the spectral division, both higher diffraction orders and the 0th diffraction order arise. This 0th diffraction order does not contain any directly evaluable information about the spectral composition of the light. With a preferably used blaze grating, the majority of the energy is in the 1st order, but the intensity of the 0th order can also be comparatively high, since the entire spectral range is superimposed here. Optionally, the device includes additional light-sensitive elements (for example photodiodes), which are each arranged in the beam path of the partial beams for detecting the 0th diffraction order. Thus, by additionally determining the light intensity of the 0th order, the total intensity can be recorded over time with a high sampling rate.

Furthermore, a high-energy filter unit can be provided which is arranged in front of the reflecting beam splitter in the direction of propagation of the optical radiation and which strongly attenuates, absorbs or couples out high-energy optical radiation.

In particular, a so-called band-stop filter, also referred to as band-rejection filter, can be used, which strongly attenuates or completely blocks incident light of a predetermined narrow frequency band (such as radiation in the laser wavelength range). Alternatively, in the variant of decoupling the high-energy radiation, it can also be detected and evaluated by another light-sensitive element.

In addition, it can be provided that the evaluation device includes a high-resolution analog-digital conversion unit. The analog-digital conversion unit can be designed with multiple channels and/or have a high resolution of up to 20 bits.

According to one embodiment, the light-sensitive elements have a number of photoactive individual elements which are each sensitive to a predefined wavelength range, wherein the channels to be used for a radiation intensity measurement are specifically selectable by means of the evaluation device.

### BRIEF DESCRIPTION OF THE DRAWINGS

The invention is explained in more detail below on the basis of an exemplary embodiment, wherein identical or similar features are provided with the same reference symbols. For this purpose, in a schematic representation,

FIG. 1: shows a side view of a device;

FIG. 2: shows a plan view of the device;

FIG. 3: shows an embodiment of the reflective beam splitter in a side view; and

FIG. 4: shows the embodiment of the reflective beam splitter in plan view.

### DETAILED DESCRIPTION OF THE PREFERRED EMBODIMENTS

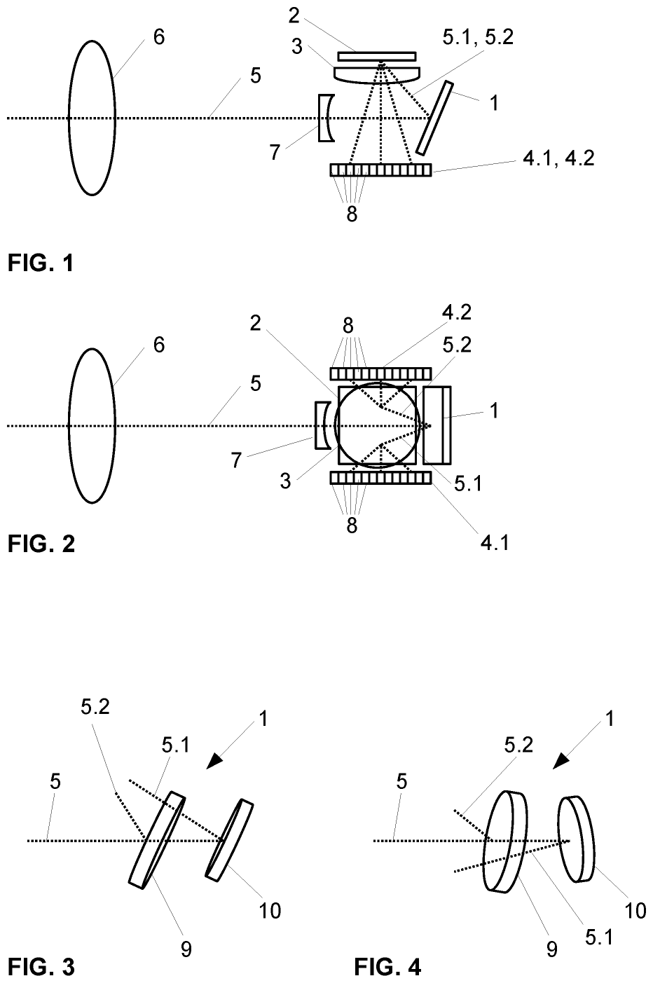

The device according to FIGS. 1 and 2 comprises the achromat 6 and the negatives lens 7, by means of which the beam diameter is reduced and the optical radiation 5 to be analyzed is directed onto the reflecting beam splitter 1. The reflecting beam splitter 1 divides the optical radiation 5 into the two partial beams 5.1 and 5.2 and deflects it through the focusing lens 3 onto the diffraction grating 2.

The diffraction grating 2 divides each of the two partial beams 5.1 and 5.2 into its spectral components, so that they are fanned out and pass through the focusing lens 3 onto the respectively associated light-sensitive elements 4.1 and 4.2.

In this exemplary embodiment, the light-sensitive elements 4.1 and 4.2 are linearly formed, comprising a plurality of adjacently arranged photoactive individual elements 8, the signal outputs of which are each separately connected to a dedicated input channel of an evaluation device (not shown).

FIGS. 3 and 4 show an embodiment of the reflective beam splitter 1, which has the two differently oriented partially reflecting mirrors 9 and 10. The views here correspond to the views of FIGS. 1 and 2. A portion of the incident optical radiation 5, namely the visible wavelength range (VIS), is reflected by the mirror 9, while the radiation in the near-infrared range (NIR) is transmitted through the mirror 9. This portion of the optical radiation 5 is reflected from the mirror 10 back through the mirror 9 (onto the diffraction grating 2—not shown). Since both mirrors 9 and 10 are tilted relative to one another, the partial beams 5.1 and 5.2 are reflected in different directions, so that they impinge the diffraction grating 2 (not shown) at different positions. They are, so to speak, separated in the 3rd dimension.

### LIST OF REFERENCE NUMERALS

1 reflective beam splitter
2 diffraction grating
3 lens
4.1 light-sensitive element
4.2 light-sensitive element
5 optical radiation
5.1 partial beam
5.2 partial beam
6 achromat
7 negative lens
8 photoactive individual element
9 partially reflecting mirror
10 partially reflecting mirror

1. Device for the spectrally resolved detection of optical radiation during a thermal process, comprising an evaluation device, at least one, in a predefined wavelength range light-sensitive element, a reflective diffraction grating and at least one lens for collimation and/or focusing, wherein the at least one lens is arranged in front of the diffraction grating, and wherein the optical radiation is directed through the at least one lens onto the diffraction grating, is spectrally separated from the diffraction grating and is directed back through the at least one lens onto the at least one light-sensitive element,
characterized in that,
the device comprises a mirror arranged along the propagation direction of the optical radiation in front of the at least one lens and the diffraction grating, and two light-sensitive elements, each of which is sensitive to a predefined wavelength range that is different from the other light-sensitive element, wherein the mirror is a reflecting beam splitter which converts the incident optical radiation into two partial beams which are spectrally separated from the diffraction grating and are directed back through the at least one lens onto in each case one of the light-sensitive elements.

2. Device according to claim 1, characterized in that the light-sensitive elements comprise a number of photoactive individual elements which are each connected to an input channel of the evaluation device, wherein the input channels are combinable in channel groups by means of the evaluation device.

3. Device according to claim 1, characterized in that a first light-sensitive element is sensitive in the visible wavelength range and a second light-sensitive element is sensitive in the near infrared range.

4. Device according to claim 1, characterized in that the light-sensitive elements are photodiode arrays.

5. Device according to claim 1, characterized in that it comprises two further light-sensitive elements, each of which is arranged in the beam path of the partial beams for detecting the 0th diffraction order.

6. Device according to claim 1, characterized in that it has a high-energy filter unit arranged in front of the reflecting beam splitter in the direction of propagation of the optical radiation, which couples out high-energy optical radiation.

7. Device according to claim 1, characterized in that the evaluation device comprises a high-resolution analog-digital conversion unit.

8. Device according to claim 1, characterized in that the light-sensitive elements comprise a number of photoactive individual elements, each of which is connected to an input channel of the evaluation device, wherein the input channels to be used for a radiation intensity measurement are specifically selectable by means of the evaluation device.

9. Device according to claim 1, characterized in that the beam splitter has an arrangement of partially reflecting mirrors which are oriented differently along the beam path of the incident optical beam, wherein each of the partially reflecting mirrors directs a partial beam of a respective predefined wavelength range of the optical radiation onto a predefined region of the diffraction grating, and wherein at least the partially reflecting mirror arranged at the front in relation to the incident optical radiation is transparent for radiation outside the predefined wavelength range.
